(19) United States
(12) Patent Application Publication
(10) Pub. No.: US 2018/0330226 A1
(43) Pub. Date: Nov. 15, 2018

(54) QUESTION RECOMMENDATION METHOD AND DEVICE

(71) Applicant: ALIBABA GROUP HOLDING LIMITED, George Town (KY)

(72) Inventors: Xiaoyan JIANG, Hangzhou (CN); Bin DAI, Hangzhou (CN); Xu YANG, Hangzhou (CN); Wei CHU, Hangzhou (CN); Yao ZHAO, Hangzhou (CN)

(73) Assignee: ALIBABA GROUP HOLDING LIMITED

(21) Appl. No.: 16/046,800

(22) Filed: Jul. 26, 2018

Related U.S. Application Data
(63) Continuation of application No. PCT/CN2017/071704, filed on Jan. 19, 2017.

(30) Foreign Application Priority Data
Jan. 29, 2016 (CN) 201610065638.2

(51) Int. Cl. G06N 3/04

(52) U.S. Cl. CPC G06N 3/0472; G06N 3/084

(57) ABSTRACT

The present disclosure provides question recommendation methods and devices. One exemplary method comprises: acquiring questions and question features corresponding to the questions; processing the question features, the processed question features being in a preset numerical range; and determining a to-be-recommended question according to the questions, a second probability of each question among the questions, and a specified recommendation threshold, wherein the second probability of each question among the questions is obtained by using the processed question features and first probabilities, the first probabilities being obtained based on the question features. By using the methods and devices in the present disclosure, a question to be recommended to a user can be obtained by performing calculation on historical question features, thereby improving accuracy of question recommendation to the user.

This application claims priority to International Application No. PCT/CN2017/071704, filed on Jan. 19, 2017, which claims priority to and the benefits of priority to Chinese Application No. 201610065638.2, filed on Jan. 29, 2016, both of which are incorporated herein by reference in their entireties.

### TECHNICAL FIELD

The present disclosure generally relates to the field of communications technologies, and in particular, to methods and devices for question recommendation.

### BACKGROUND

With the rising popularity of festivals such as the Chinese Double Eleven and Double Twelve festivals, an increasing number of people shop online. The “festival economy,” however, also causes significant impacts on e-commerce companies, such as sales explosions and increasing pressure on customer service. The customer service of a company generally includes manual customer service and self-help customer service. Increasing pressure on customer service forces companies to add more staff to provide manual customer service, and the associated costs rise accordingly.

In view of the above, there is a need for self-help customer service systems with more powerful processing capacities to meet the requirements of customer service. Self-help customer service system can process and answer customers' questions automatically. However, with the increasing amount of data to be processed by self-help customer service systems, the existing methods are unable to process such amount of data. The computing efficiency of existing algorithms declines as the number of questions increases. Moreover, most features of the questions are sparse, while the existing techniques are suitable for processing dense features. Therefore the accuracy of user question prediction decreases as the amount of question features increases. In addition, the technical effect of existing methods is limited as the models used in the existing technologies are limited. Therefore, given the explosions of the data, current machine learning models can no longer satisfy the processing requirements.

Therefore, there is a need of processing techniques based on historical question features to obtain questions to be recommended to the users, to improve the accuracy of questions recommended to users. That way, it can help to address the users' questions at a self-help customer service node, thereby reducing the number of users using manual customer service and lowering the costs associated with manual customer service.

### SUMMARY

According to some embodiments of the present disclosure, question recommendation methods are provided. One objective of the present disclosure is to improve the accuracy of question recommendation to users. One exemplary question recommendation method includes the following procedures: acquiring questions and question features corresponding to the questions; processing the question features, the processed question features being in a preset numerical range; and determining a to-be-recommended question according to the questions, a second probability of each question among the questions, and a specified recommendation threshold. The questions and the second probability of each question among the questions can be obtained by using the processed question features and first probabilities, the first probabilities being obtained based on the question features.

In some embodiments, the question features include numerical features and textual features, the numerical features are continuous, and the textual features are discontinuous.

In some embodiments, the acquiring questions can include: acquiring the questions in a feature acquisition cycle; if there is a question not acquired in the feature acquisition cycle, setting a value of the question not acquired to null; and if there is no question not acquired in the feature acquisition cycle, using the acquired questions as the questions.

In some embodiments, the acquiring question features corresponding to the questions can include: acquiring question features in a feature acquisition cycle; if there is a question feature not acquired in the feature acquisition cycle and the question feature is a numerical feature, using an average value of numerical values of the acquired question features corresponding to the questions as the question feature; if there is a question feature not acquired in the feature acquisition cycle and the question feature is a textual question feature, using a question feature with a highest frequency of occurrence in the acquired question features corresponding to the questions as the question feature; and if there is no question feature not acquired in the feature acquisition cycle, using the acquired question features as the question features.

In some embodiments, the processing the question features can include: performing normalization processing on the question features if the question features are numerical question features; and performing vectorization processing on the question features if the question features are textual question features, a question feature obtained after the vectorization processing being a numerical question feature.

In some embodiments, the second probabilities are obtained by performing Deep Neural Network (DNN) calculations on the processed question features and the first probabilities.

According to some embodiments of the present disclosure, question recommendation devices are provided. One question recommendation device includes: an acquisition module configured to acquire questions and question features corresponding to the questions; a processing module configured to process the question features, the processed question features being in a preset numerical range; and a determination module configured to determine a to-be-recommended question according to the questions, a second probability of each question among the questions, and a specified recommendation threshold. The questions and the second probability of each question among the questions can be obtained by using the processed question features and first probabilities. The first probabilities can be obtained based on the question features.

In some embodiments, the question features include numerical features and textual features, the numerical features are continuous, and the textual features are discontinuous.

In some embodiments, the acquisition module can be further configured to: acquire the questions in a feature acquisition cycle; if there is a question not acquired in the feature acquisition cycle, set a value of the question not acquired to null; and if there is no question not acquired in the feature acquisition cycle, use the acquired questions as the questions.

In some embodiments, the acquisition module can be further configured to: acquire question features in a feature acquisition cycle; if there is a question feature not acquired in the feature acquisition cycle and the question feature is a numerical feature, use an average value of numerical values of the acquired question features corresponding to the questions as the question feature; if there is a question feature not acquired in the feature acquisition cycle and the question feature is a textual question feature, use a question feature with a highest frequency of occurrence in the acquired question features corresponding to the questions as the question feature; and if there is no question feature not acquired in the feature acquisition cycle, use the acquired question features as the question features.

In some embodiments, the processing module can be further configured to: perform normalization processing on the question features if the question features are numerical question features; and perform vectorization processing on the question features if the question features are textual question features, a question feature obtained after the vectorization processing being a numerical question feature.

In some embodiments, the second probabilities are obtained by performing DNN calculations on the processed question features and the first probabilities.

In view of the above, by using the technical solutions of the present disclosure, question features can be processed and subject to classification calculation. Further calculation can be then performed on obtained results. That way, the questions and second probabilities can be obtained accurately. Embodiments of the present disclosure can improve the accuracy of question recommendation to users. Technical solutions provided in the present disclosure can be used to process dense question features. Further, they can also be applied to process large-scale sparse data, and improve the accuracy of prediction.

### BRIEF DESCRIPTION OF THE DRAWINGS

FIG. 1 is a schematic flowchart of an exemplary question recommendation method according to some embodiments of the present disclosure.

FIG. 2 is a schematic diagram of an exemplary DNN model according to some embodiments of the present disclosure.

FIG. 3 is a schematic structural diagram of an exemplary question recommendation device according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods according to some embodiments of the present disclosure, the scope of which is defined by the appended claims.

In view of the problems in the existing technologies, the present disclosure provides question recommendation methods. The questions recommendation methods can be applied to, for example, a question recommendation system. Model training can be carried out using a combination of a machine learning model and a DNN model. The question recommendation system can recommend a user-required question to a user according to historical data. Further, the question recommendation system can process sparse and dense question features and can be used for improving the accuracy of question recommendation to the user.

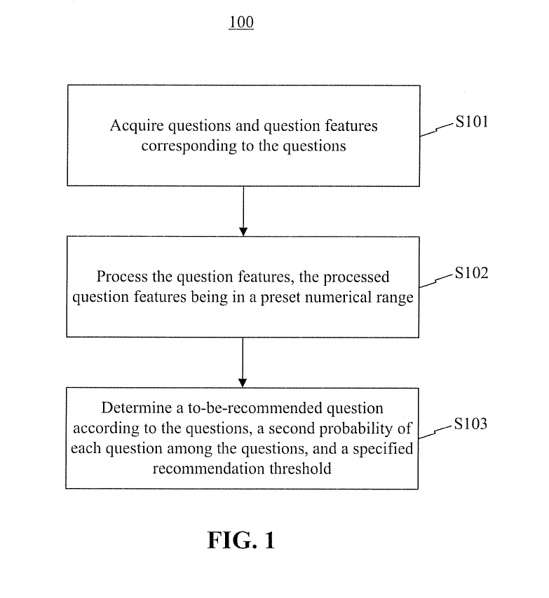

Referring to FIG. 1, FIG. 1 is a schematic flowchart of an exemplary question recommendation method 100 according to some embodiments of the present disclosure. The exemplary method 100 includes the following procedures S101-S103.

In step S101, questions and question features corresponding to the questions are acquired. One objective of the present disclosure is to help recommend a question to a user who needs a question recommendation service. Users can include users to whom the question needs to be recommended and other users. Historical records of the users can be stored in a question recommendation system, according to some embodiments of the present disclosure. The historical records can include questions and corresponding question features. The question recommendation system can include a collection layer, a processing layer, a storage layer and an output layer. The collection layer can be used for collecting questions sent from user devices and question features. The processing layer can be used for carrying out model training by using the collected questions and question features. The storage layer is responsible for data storage, and can store the historical records of the users. The output layer outputs questions and question features. The question recommendation system according to some embodiments of the present disclosure can be implemented, for example, on a server. In some embodiments, a distributed server can be used. Moreover, in some embodiments of the present disclosure, one server or a cluster consisting of multiple servers can be used.

The question features can include numerical features and textual features. The numerical features are continuous. For example, the numerical feature can be the number of times that certain application software is used. A numerical value 9 can represent that the application software is used 9 times. The textual features are discontinuous. For example, the textual feature can be an invoice status, which can correspond to a non-invoiced state and an invoiced state. Further, as questions and question features in the historical records may be valid only in a particular period of time, a sample collection cycle can be set to collect questions and question features in a corresponding period of time. For example, the sample collection cycle can be one week or one month. When other devices send questions and question features to the system, it can take a relatively long time to acquire some questions and question features because different devices have different IP addresses. As a result, the system may not be able to complete acquisition in a long time.

In order to process data more efficiently, in some embodiments of the present disclosure, a feature acquisition cycle is set, and the questions are acquired in the feature acquisition cycle. If there is a question not acquired in the feature acquisition cycle, a value of the question not acquired can be set null. If there is no question not acquired in the feature acquisition cycle, the acquired questions can be used as the questions. Similarly, question features can be acquired in the feature acquisition cycle. If there is a question feature not acquired in the feature acquisition cycle and the question feature is a numerical feature, an average value of numerical values of the acquired question features corresponding to the questions can be used as the question feature. If there is a question feature not acquired in the feature acquisition cycle and the question feature is a textual question feature, a question feature with a highest frequency of occurrence in the acquired question features corresponding to the questions can be used as the question feature. If there is no question feature not acquired in the feature acquisition cycle, the acquired question features can be used as the question features.

After acquiring the questions and the question features corresponding to the questions, the recommendation system can screen the question features to delete some features. For example, the system can delete identical question features possessed by all the users, question features that are present beyond the feature acquisition cycle, and question features irrelevant to business services. Features obtained after the screening can be used for building a classification model subsequently.

In step S102, the question features can be processed, the processed question features being in a preset numerical range. After acquiring the questions and the corresponding question features, the question recommendation system processes the question features. Normalization processing can be performed on the question feature if the question feature is a numerical question feature, and the processed question feature can be in a specified numerical range. Vectorization processing can be performed on the question feature if the question feature is a textual question feature. The processed question feature then becomes a numerical question feature and can be in the specified question feature.

In some embodiments of the present disclosure, if question features are numerical features, normalization processing can be performed on the question features by using a percentile binning algorithm. That way, all the question features can be in a specified numerical range after processing. During processing based on the percentile binning algorithm, original numerical values are categorized into 100 bins, and then the bins can be coded, for example, 0.01, 0.02 . . . , 1.00. The processed numerical question features are in a numerical range of 0 to 1.

Textual question features are presented in the form of texts and may not be directly used in calculation. Therefore, it may be necessary to perform vectorization processing on the textual question features to convert the question features from textual features into numerical features. One hot encoding may be employed to process the textual features and calculate a frequency of each feature. One hot codes can be provided based on the frequencies. For example, the textual feature can be an invoice status corresponding to a non-invoiced state or an invoiced state. Numerical features 0 and 1 can be obtained after vectorization processing, which are in the numerical range of 0 to 1.

After processing, the question features are in the specified numerical range, which can facilitate subsequent calculation. In the above example, the percentile binning algorithm and vectorization processing methods are performed, as question features in the specified numerical range are obtained in the present disclosure. It is appreciated that the above methods are only exemplary, and are not intended to limit the scope of the present disclosure. Consistent with the present disclosure, other manners may be selected for calculation. It is appreciated that the present disclosure is applicable to other application scenarios not described herein. Variations and improvements consistent with the present disclosure all belong to the protection scope of the present disclosure.

In step S103, a to-be-recommended question is determined according to the questions, a second probability of each question among the questions, and a specified recommendation threshold.

After the questions and the corresponding question features are obtained, calculation can be performed on the question features based on a classification model to obtain first probabilities, for example, by using a decision tree algorithm. During calculation based on a decision tree, two rounds of sampling can be performed first. In the first round, the question features are randomly sampled to obtain question features that can be processed by the decision tree. In the second round, important features are sampled, and weights are calculated according to the question features that can be processed.

With the increase of data interfaces, original variables and derivative variables of data sets also increase. Information Value (IV) can be critical in data applications. IV can be used to represent the amount of “information” that each variable contributes to a target variable, the use of which can help to improve the efficiency of feature selection.

During the process of feature selection, features are usually selected after the importance of the features is quantified. How to quantify the features can be a big difference among various methods. With respect to Information Gain (IG), a criterion for measuring the importance is represented by how much information a feature can contribute to a classification system. The more information a feature contributes to the system, the more important the feature is. Therefore, for a feature, a difference between an information amount of the system in the presence of the feature and an information amount of the system in the absence of the feature can represent the amount of information that the feature contributes to the system, i.e., the IG.

In some embodiments, IV and IG can be used to represent the weight corresponding to the question feature. Therefore, the weight can be IV and/or IG. Important features can be selected according to the weights. A classification model can then be established according to the important features. The question features obtained after screening can be analyzed based on the classification model to obtain first probabilities. For example, probabilities obtained after the question features are subject to calculation based on the decision tree algorithm can be used as the first probabilities.

It is appreciated that, the foregoing process of obtaining probability values corresponding to the question features based on the decision tree algorithm is merely an example. Apart from that, other calculation methods such as logical regression calculation may also be selected. It is appreciated that the present disclosure is applicable to various application scenarios. Variations or improvements consistent with the present disclosure all belong to the protection scope of the present disclosure.

After the processed question features and the first probabilities are obtained, one or more calculations can be performed on the processed question features and the first probabilities to obtain the questions and the second probability of each question among the questions. In some embodiments, the questions and the second probability of each question among the questions can be obtained by means of DNN (Deep Neural Networks) calculation.

A DNN used for the question recommendation system can include an input node and a calculation node. The DNN calculations can include the following procedures. The input node acquires the processed question features and the first probabilities. The calculation node performs calculation on the processed question features and the first probabilities by using a fully connected layer, an activation function ReLu and a multi-class loss function softmax loss, to obtain the second probabilities.

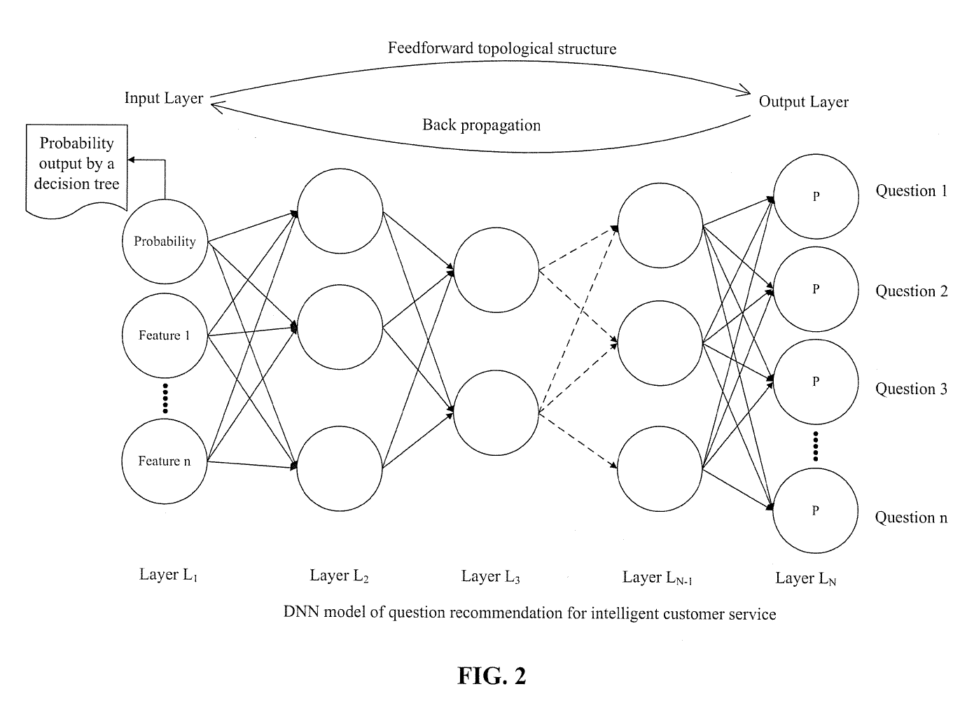

FIG. 2 shows the operations in an exemplary application scenario. As shown in FIG. 2, the operations can include the following procedures.

a. An input layer acquires the processed question features and the first probabilities.

Before DNN training, the data can be classified preliminarily by using a decision tree. Weights of network nodes in the DNN can be determined based on the first probabilities.

b. An intermediate layer, i.e., a calculation layer, recommends questions. The calculation layer can perform calculations on the processed question features and the first probabilities by using a fully connected layer, an activation function ReLu and a multi-class loss function softmax loss, to obtain questions corresponding to the question features and the second probabilities.

By performing calculations based on the activation function ReLu, the output of some neurons in the network is 0, which contributes to the sparsity of the network. That way, it reduces interdependency between parameters, and alleviates the overfitting problem. Further, the calculation node has a relatively small calculation amount, which helps to improve the efficiency of question recommendation of the system. In addition, a GPU can be used in the DNN training to accelerate matrix calculations, thus further improving the calculation speed. In addition to the activation function ReLu, a sigmoid layer can also be used for calculation.

c. An output layer outputs the questions and the second probabilities corresponding to the questions.

It is appreciated that, in this example, the second probabilities are obtained from the first probabilities and the numerical question features that are obtained after processing. The calculation manner used in this example is DNN calculations. But the protection scope of the present disclosure is not limited to DNN calculation. The above implementation is merely an example. Based on this example, other manners can also be selected for calculation. It is appreciated that the present disclosure is applicable to various application scenarios. Variations and improvements consistent with the present disclosure shall all belong to the protection scope of the present disclosure.

In some embodiments of the present disclosure, the question recommendation system determines a to-be-recommended question according to the questions, a second probability of each question among the questions, and a specified recommendation threshold. A question feature satisfying the threshold can be obtained according to the threshold. A question corresponding to the question feature can be used as the to-be-recommended question. For example, if question features of six questions are obtained that satisfy the threshold, the system can recommend the six questions. In some embodiments of the present disclosure, after calculation is performed on the questions and question features in historical records corresponding to users and thus to-be-recommended questions are determined, a corresponding result can be directly invoked when a user accesses the question recommendation system. By using the question recommendation system according to these embodiments, the user can directly acquire questions that are highly relevant to the user.

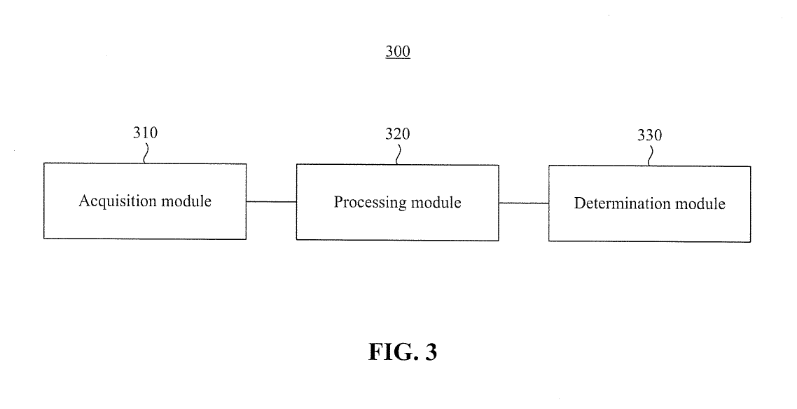

According to some embodiments of the present disclosure, question recommendation devices are further provided. As shown in FIG. 3, one exemplary question recommendation device 300 includes an acquisition module 310, a processing module 320, and a determination module 330.

The acquisition module 310 can be configured to acquire questions and question features corresponding to the questions.

The processing module 320 can be configured to process the question features, the processed question features being in a preset numerical range.

The determination module 330 can be configured to determine a to-be-recommended question according to the questions, a second probability of each question among the questions, and a specified recommendation threshold.

The questions and the second probability of each question among the questions can be obtained by using the processed question features and first probabilities, the first probabilities being obtained based on the question features.

In some embodiments, the question features can include numerical features and textual features. The numerical features are continuous, and the textual features are discontinuous.

In some embodiments, the acquisition module 310 can be further configured to: acquire the questions in a feature acquisition cycle; if there is a question not acquired in the feature acquisition cycle, set a value of the question not acquired to null; and if there is no question not acquired in the feature acquisition cycle, use the acquired questions as the questions.

In some embodiments, the acquisition module 310 can be further configured to: acquire question features in a feature acquisition cycle; if there is a question feature not acquired in the feature acquisition cycle and the question feature is a numerical feature, use an average value of numerical values of the acquired question features corresponding to the questions as the question feature; if there is a question feature not acquired in the feature acquisition cycle and the question feature is a textual question feature, use a question feature with a highest frequency of occurrence in the acquired question features corresponding to the questions as the question feature; and if there is no question feature not acquired in the feature acquisition cycle, use the acquired question features as the question features.

In some embodiments, the processing module 320 can be further configured to: perform normalization processing on the question features if the question features are numerical question features; and perform vectorization processing on the question features if the question features are textual question features, a question feature obtained after the vectorization processing being a numerical question feature.

In some embodiments, the second probabilities are obtained by performing DNN calculations on the processed question features and the first probabilities.

According to the description of the foregoing implementations, it is appreciated that some embodiments of the present disclosure can be implemented by hardware or implemented by software plus a hardware platform. Based on such understanding, the technical solution of the present disclosure can be embodied in the form of a software product. The computer software product can be stored in a non-volatile storage medium, and can include several instructions for instructing a computer device to execute the methods according to various embodiments of the present disclosure. The storage medium can include, for example, a CD-ROM, a USB flash drive, or a mobile hard disk drive. The computer device can include, for example, a personal computer, a server, a network device, or the like.

For example, one or more of the modules 310-330 as described above with reference to FIG. 3 may be implemented in the form of a computer program product implemented on one or more computer usable storage media including computer-readable program codes therein. The storage media can include a set of instructions for instructing a computer device or a processor to perform a part of the steps of the methods described in the embodiments of the present disclosure. The foregoing storage medium may include, for example, any medium that can store a program code, such as a USB flash disk, a removable hard disk, a Read-Only Memory (ROM), a Random Access Memory (RAM), a magnetic disk, or an optical disc. The storage medium can be a non-transitory computer readable medium. Common forms of non-transitory media include, for example, a floppy disk, a flexible disk, hard disk, solid state drive, cloud storage, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM any other memory chip or cartridge, and networked versions of the same.

It is appreciated that the accompanying drawings are merely schematic diagrams of some exemplary application scenarios. Modules or processes in the accompanying drawings are not necessarily mandatory to other implementations of the present disclosure.

It is appreciated that modules in an apparatus in some implementation scenarios can be distributed in the apparatus, and can also be located in one or more apparatuses different from the apparatus described above in the exemplary scenario. The modules in the implementation scenario can be combined into one module, and can also be further divided into multiple sub-modules. Further, the sequence numbers in the present disclosure are merely for the convenience of description, and do not imply the preference among implementation scenarios.

Some exemplary embodiments of the present disclosure are described above. However, the present disclosure is not limited to these implementation scenarios. Variations that can be conceived of by those skilled in the art based on the present disclosure shall all fall in the protection scope of the present disclosure.

1. A question recommendation method, comprising:
acquiring questions and question features corresponding to the questions;
processing the question features, the processed question features being in a preset numerical range; and
determining a to-be-recommended question according to the questions, a second probability associated with each question among the questions, and a recommendation threshold,
wherein the second probability of each question among the questions is obtained by using the processed question features and first probabilities, the first probabilities being obtained based on the question features.

2. The method according to claim 1, wherein the question features include at least one of numerical features and textual features, the numerical features being continuous, and the textual features being discontinuous.

3. The method according to claim 2, wherein acquiring question features corresponding to the questions comprises:
acquiring question features in a feature acquisition cycle;
in response to a numerical question feature not being acquired in the feature acquisition cycle, determining an average value of numerical values of the acquired question features as the numerical question feature; or
in response to a textual question feature not being acquired in the feature acquisition cycle, determining a question feature with a highest frequency of occurrence in the acquired question features as the textual question feature.

4. The method according to claim 2, wherein processing the question features comprises:
performing normalization processing on a question feature in response to the question feature being a numerical question feature; and
performing vectorization processing on a question feature in response to the question feature being a textual question feature, a question feature obtained after the vectorization processing being a numerical question feature.

5. The method according to claim 1, wherein acquiring questions comprises:
acquiring the questions in a feature acquisition cycle; and
in response to a question not being acquired in the feature acquisition cycle, setting a value associated with the question to null.

6. The method according to claim 1, wherein the second probability is obtained by performing Deep Neural Network (DNN) calculations based on the processed question features and the first probabilities.

7. The method according to claim 1, wherein the first probabilities are obtained by using a decision tree algorithm based on the question features.

8. A question recommendation device, comprising:
a memory storing a set of instructions; and
a processor configured to execute the set of instructions to cause the question recommendation device to perform:
acquiring questions and question features corresponding to the questions;
processing the question features, the processed question features being in a preset numerical range; and
determining a to-be-recommended question according to the questions, a second probability of each question among the questions, and a recommendation threshold,
wherein the second probability of each question among the questions is obtained by using the processed question features and first probabilities, the first probabilities being obtained based on the question features.

9. The question recommendation device according to claim 8, wherein the question features include at least one of numerical features and textual features, the numerical features being continuous, and the textual features being discontinuous.

10. The question recommendation device according to claim 9, wherein the processor is further configured to execute the set of instructions to cause the question recommendation device to perform:
acquiring question features in a feature acquisition cycle;
if a numerical question feature is not acquired in the feature acquisition cycle, determining an average value of numerical values of the acquired question features corresponding to the questions as the numerical question feature; and
if a textual question feature is not acquired in the feature acquisition cycle, determining a question feature with a highest frequency of occurrence in the acquired question features corresponding to the questions as the textual question feature.

11. The question recommendation device according to claim 9, wherein the processor is further configured to execute the set of instructions to cause the question recommendation device to perform:
performing normalization processing on a question feature if the question feature is a numerical question feature; and
performing vectorization processing on a question feature if the question feature is a textual question feature, a question feature obtained after the vectorization processing being a numerical question feature.

12. The question recommendation device according to claim 8, wherein the processor is further configured to execute the set of instructions to cause the question recommendation device to perform:
acquiring the questions in a feature acquisition cycle; and
if a question not acquired in the feature acquisition cycle, setting a value associated with the question not acquired to null.

13. The question recommendation device according to claim 8, wherein the second probability is obtained by performing Deep Neural Network (DNN) calculations based on the processed question features and the first probabilities.

14. The question recommendation device according to claim 8, wherein the first probabilities are obtained by using a decision tree algorithm based on the question features.

15. A non-transitory computer readable medium that stores a set of instructions that is executable by at least one processor of question recommendation device to cause the device to perform a question recommendation method, comprising:
acquiring questions and question features corresponding to the questions;
processing the question features, the processed question features being in a preset numerical range; and
determining a to-be-recommended question according to the questions, a second probability associated with each question among the questions, and a recommendation threshold,
wherein the second probability of each question among the questions is obtained by using the processed question features and first probabilities, the first probabilities being obtained based on the question features.

16. The non-transitory computer readable medium according to claim 15, wherein the question features include at least one of numerical features and textual features, the numerical features being continuous, and the textual features being discontinuous.

17. The non-transitory computer readable medium according to claim 16, wherein acquiring question features corresponding to the questions comprises:
acquiring question features in a feature acquisition cycle;
if a numerical question feature is not acquired in the feature acquisition cycle, determining an average value of numerical values of the acquired question features as the numerical question feature; and
if a textual question feature is not acquired in the feature acquisition cycle, determining a question feature with a highest frequency of occurrence in the acquired question features as the textual question feature.

18. The non-transitory computer readable medium according to claim 16, wherein processing the question features comprises:
performing normalization processing on a question feature if the question feature is a numerical question feature; and
performing vectorization processing on a question feature if the question feature is a textual question feature, a question feature obtained after the vectorization processing being a numerical question feature.

19. The non-transitory computer readable medium according to claim 15, wherein acquiring questions comprises:
acquiring the questions in a feature acquisition cycle; and
if a question is not acquired in the feature acquisition cycle, setting a value associated with the question to null.

20. The non-transitory computer readable medium according to claim 15, wherein the second probability is obtained by performing Deep Neural Network (DNN) calculations based on the processed question features and the first probabilities.
